(19) United States
(12) Patent Application Publication
(10) Pub. No.: US 2025/0309338 A1
(43) Pub. Date: Oct. 2, 2025

(54) METHOD OF MANUFACTURING SOLID ELECTROLYTE LAYER USING SPARK PLASMA SINTERING AND SOLID ELECTROLYTE LAYER MANUFACTURED BY THE SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Seong Hyeon Choi, Seongnam (KR); Yong Gu Kim, Suwon (KR); Sang Heon Lee, Seongnam (KR); Sun Ho Choi, Incheon (KR); Yong Jun Jang, Seongnam (KR); Sung Man Cho, Gwacheon (KR); In Chung, Seoul (KR); Jae Ho Lee, Seoul (KR); Da Woon Kim, Seoul (KR)

(21) Appl. No.: 18/785,637

(22) Filed: Jul. 26, 2024

(30) Foreign Application Priority Data
Apr. 2, 2024 (KR) 10-2024-0044435

(51) Int. Cl. H01M 10/0562; H01M 50/403; H01M 50/431

(52) U.S. Cl. CPC H01M 10/0562; H01M 50/403; H01M 50/431; H01M 2300/008

(57) ABSTRACT

A method of manufacturing a solid electrolyte layer using spark plasma sintering and a solid electrolyte layer manufactured thereby, wherein an amorphous solid electrolyte is crystallized using spark plasma sintering. Accordingly, a solid electrolyte layer with high density and excellent lithium ion conductivity can be produced at a relatively low pressure only by rapid sintering.

### CROSS-REFERENCE TO RELATED APPLICATION

This application claims, under 35 U.S.C. § 119 (a), the benefit of Korean Patent Application No. 10-2024-0044435, filed on Apr. 2, 2024, the entire contents of which are incorporated herein by reference.

### TECHNICAL FIELD

The present disclosure relates to a method of manufacturing a solid electrolyte layer using spark plasma sintering and a solid electrolyte layer manufactured by this method. In this process, an amorphous solid electrolyte is crystallized using spark plasma sintering. Consequently, it is possible to produce a solid electrolyte layer with high density and excellent lithium ion conductivity at a relatively low pressure through rapid sintering.

### BACKGROUND

Unlike a conventional lithium-ion battery wherein a separator is located between the cathode and the anode, and a liquid electrolyte is responsible for moving lithium ions to both the cathode and the anode, in an all-solid-state battery, a solid electrolyte layer serves as both a separator and a liquid electrolyte.

Materials for a solid electrolyte layer include sulfide-based solid electrolytes, oxide-based solid electrolytes, and halide-based solid electrolytes. Among these, sulfide-based solid electrolytes are emerging as the most suitable material for next-generation solid-state batteries due to low price, high ionic conductivity and low electronic conductivity, easy synthesis mechanism, and excellent performance.

Despite these advantages, conventional sulfide-based solid electrolytes also have many limitations.

First, conventional sulfide-based solid electrolytes are formed by heat-treating the produced amorphous sulfide-based solid electrolyte under an Ar atmosphere at a high temperature for a long time to obtain crystalline solid electrolytes, and then applying high pressure thereto to form films. Here, in order to increase the crystallinity of the sulfide-based solid electrolytes, heat treatment is required, which makes it difficult to synthesize a uniform crystalline material due to the temperature gradient of the heat treatment furnace. The resulting differences in crystallinity of the solid electrolytes cause uneven movement of lithium ions in the solid electrolyte layer, thus causing a decrease in ionic conductivity, uneven current density, and thus a short circuit at high current density.

Second, even the same sulfide-based solid electrolyte can exhibit differences in the electrolyte depending on the composition/synthesis method, which makes it challenging to easily produce the solid electrolyte layer at high density. In addition, due to the nature of all-solid-state batteries, high pressure must be applied to ensure contact between particles, which hinders the ability to increase the cell area.

Therefore, even at low pressure, the solid electrolyte layer must be able to exhibit high density and thus excellent lithium ion conductivity.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art and it is one object of the present disclosure to provide a solid electrolyte layer by sintering at a relatively low pressure for a short time compared to conventional methods of manufacturing solid electrolyte layers. In particular, a solid electrolyte layer is manufactured by crystallizing an amorphous solid electrolyte using spark plasma sintering (SPS).

It is another object of the present disclosure to manufacture a solid electrolyte layer using spark plasma sintering at a relatively low pressure for a short time and increase the area thereof.

The objects of the present disclosure are not limited to those described above. Other objects of the present disclosure will be clearly understood from the following description, and are able to be implemented by means defined in the claims and combinations thereof.

In one aspect, the present disclosure provides a method of crystallizing the amorphous solid electrolyte using spark plasma sintering (SPS) to manufacture a solid electrolyte layer comprising a crystalline solid electrolyte.

In an embodiment, the preparing the amorphous solid electrolyte may include performing mechanical milling on solid electrolyte raw materials.

In an embodiment, the mechanical milling may include at least one selected from the group consisting of ball milling, airjet milling, bead milling, roll milling, planetary milling, hand milling, high energy ball milling, planetary ball milling, stirred ball milling, vibrating milling, mechanofusion milling, shaker milling, planetary milling, attritor milling, disk milling, shape milling, Nauta milling, Nobilta milling, high speed mixing, and combinations thereof.

In an embodiment, the crystallizing the amorphous solid electrolyte using SPS may include placing the amorphous solid electrolyte into a spark plasma sintering device, vaccumizing the spark plasma sintering device and applying a reaction pressure thereto, ramping a temperature of the spark plasma sintering device to the reaction temperature while maintaining the reaction pressure thereto, and maintaining the reaction temperature for a predetermined reaction time to crystallize the amorphous solid electrolyte into the crystalline solid electrolyte.

In an embodiment, the reaction pressure may be about 10 MPa to 90 MPa.

In an embodiment, the reaction time may be about 5 to 10 minutes.

In an embodiment, the reaction temperature may be about 500 K to 700 K.

In an embodiment, a temperature increase rate to reach the reaction temperature may be about 30 K/min to 100 K/min.

In an embodiment, the method may further include cooling the crystalline solid electrolyte to room temperature after the crystallization.

In an embodiment, the crystalline solid electrolyte may include a sulfide-based solid electrolyte.

In an embodiment, the crystalline solid electrolyte may have an argyrodite-type crystal structure.

In an embodiment, the crystalline solid electrolyte may be represented by the following Formula:

[Formula]

Li_{6+x-a-y}A₁₋ₓMₓS₅₋ₐX₁₊ₐ
wherein
A is P or Sb;
M is Si, Ge or Sn;
X includes any one selected from the group consisting of Cl, Br, I and combinations thereof; and
x satisfies 0≤x≤0.5, y satisfies 0≤y≤0.2, and a satisfies 0≤a≤0.5, respectively.

In an embodiment, when A in the Formula is P, spark plasma sintering may be performed at a reaction temperature of about 523K to 600K.

In an embodiment, when A in the Formula is Sb, spark plasma sintering may be performed at a reaction temperature of about 573K to 673K.

In an embodiment, the solid electrolyte layer may have an ionic conductivity of about 1.30*10⁻³ S/cm or more.

In an embodiment, a density of the solid electrolyte layer may be about 88% to 99% of a theoretical density.

In an embodiment, each element constituting the crystalline solid electrolyte is dispersed without agglomeration.

In one aspect, the present disclosure provides a solid electrolyte layer including a crystalline solid electrolyte crystallized using spark plasma sintering (SPS), wherein the crystalline solid electrolyte includes a sulfide-based solid electrolyte. In an embodiment, the solid electrolyte layer may have an ionic conductivity of about 1.30*10⁻³ S/cm or more.

In an embodiment, each element constituting the crystalline solid electrolyte is evenly dispersed without agglomeration.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 illustrates the results of XRD of a solid electrolyte layer manufactured according to the present disclosure and a solid electrolyte layer manufactured according to a conventional method;

FIG. 2 illustrates a measured impedance of the solid electrolyte layer according to Example 1;

FIG. 3 illustrates a measured impedance of the solid electrolyte layer according to Comparative Example 1;

FIG. 4 is a scanning electron microscopy (SEM) image showing the solid electrolyte layer according to Example 1;

FIGS. 5A to 5D are energy dispersive X-ray spectroscopy (EDS) images of sulfur(S), iodine (I), germanium (Ge), and antimony (Sb), respectively, in the solid electrolyte layer according to Example 1;

FIG. 6 is a scanning electron microscope (SEM) image showing the solid electrolyte layer according to Comparative Example 1;

FIGS. 7A to 7D are energy dispersive X-ray spectroscopy (EDS) images of sulfur(S), iodine (I), germanium (Ge), and antimony (Sb), respectively, in the solid electrolyte layer according to Comparative Example 1;

FIG. 8 is a scanning electron microscope (SEM, ×3,000) image showing the solid electrolyte layer according to Example 2;

FIGS. 9A to 9C are energy dispersive X-ray spectroscopy (EDS) images of sulfur(S), phosphorus (P), and chlorine (Cl), respectively, in the solid electrolyte layer according to Example 2;

FIG. 10 is a scanning electron microscope (SEM, ×3,000) image showing the solid electrolyte layer according to Comparative Example 3; and

FIGS. 11A to 11C are energy dispersive X-ray spectroscopy (EDS) images of sulfur(S), phosphorus (P), and chlorine (Cl), respectively, in the solid electrolyte layer according to Comparative Example 3.

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed contents and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include numbers such as 10%, 11%, 12% and 13%, as well as 30%, and any sub-ranges, such as 10% to 15%, 12% to 18%, or 20% to 30%, as well as any numbers, such as 10.5%, 15.5% and 25.5%, between appropriate integers that fall within the range.

The method of manufacturing a solid electrolyte layer according to an aspect of the present disclosure includes preparing an amorphous solid electrolyte and crystallizing the amorphous solid electrolyte using spark plasma sintering (SPS) to form a solid electrolyte layer containing a crystalline solid electrolyte.

Hereinafter, each step will be described in more detail.

### Preparing Amorphous Solid Electrolyte

Solid electrolytes may be divided into crystalline and amorphous (non-crystalline) electrolytes depending on the presence or absence of a crystalline structure. Typical crystalline systems include thio-LISICON, LGPS, and argyrodite crystal structures, whereas typical amorphous systems include glass or glass-ceramic structures depending on differences in heat treatment temperature.

The amorphous solid electrolyte prepared in this step may be prepared without particular restrictions as long as it can be converted to a crystalline solid electrolyte using spark plasma sintering. In addition, the amorphous solid electrolyte may be prepared, for example, as a powder.

In one embodiment, an amorphous solid electrolyte may be prepared by applying energy to a solid electrolyte raw material. Here, the solid electrolyte raw material is not particularly limited as long as it is required to synthesize the crystalline solid electrolyte according to the present disclosure. For example, the solid electrolyte raw material may include Li₂S, Ge, Sb, S, LiI, P₂S₅, LiCl, or the like. In addition, the solid electrolyte raw material may be appropriately prepared depending on the type of crystalline solid electrolyte and the dopant element.

The energy is applied mechanically and may for example include mechanical milling. The mechanical milling is not particularly limited as long as it enables the synthesis of an amorphous solid electrolyte by pulverizing or mixing the solid electrolyte raw materials, and may be any method commonly used in the relevant technical field.

The mechanical milling may, for example, include at least one selected from the group consisting of ball milling, airjet milling, bead milling, roll milling, planetary milling, hand milling, high energy ball milling, planetary ball milling, stirred ball milling, vibrating milling, mechanofusion milling, shaker milling, planetary milling, attritor milling, disk milling, shape milling, Nauta milling, Nobilta milling, high speed mixing, and combinations thereof.

In addition, the amorphous solid electrolyte may be prepared by purchasing a known one depending on the type of crystalline solid electrolyte synthesized according to the present disclosure.

### Manufacturing Solid Electrolyte Layer Using Spark Plasma Sintering

Then, the prepared amorphous solid electrolyte may be crystallized using spark plasma sintering. At this time, the amorphous solid electrolyte may be converted into a crystalline solid electrolyte.

The term “spark plasma sintering (SPS)” may refer to a method including applying pressure, low voltage, and high current to a material and then rapidly sintering the material by generating plasma. Specifically, the spark plasma sintering refers to a method that allows synthesis or sintering of the desired material in a short time and effectively uses high energy of high-temperature plasma (discharge plasma) that is generated instantly when directly applying electrical energy as a pulse to the gap between particles of the pressurized powder through heat diffusion, electric field action, or the like.

According to the present disclosure, an amorphous solid electrolyte may be crystallized into a crystalline solid electrolyte in a short time using spark plasma sintering. Compared to the conventional method that requires long-term heat treatment at a high temperature higher than 700K, crystallization may be achieved at a relatively low temperature in a short time, resulting in a denser, i.e., high-density, crystalline solid electrolyte. Consequently, the lithium ion conductivity of the solid electrolyte layer can be improved.

The spark plasma sintering used in the present disclosure may be performed using a spark plasma sintering device. The spark plasma sintering device may be used without particular limitations as long as it is capable of crystallizing an amorphous solid electrolyte into a crystalline solid electrolyte. For example, the spark plasma sintering device includes a chamber having a predetermined internal space, a mold configured to determine the size or shape of the solid electrolyte layer to be synthesized, and one or more punches configured to apply pressure to the solid electrolyte introduced into the mold.

In one embodiment, manufacturing the solid electrolyte layer may include adding the amorphous solid electrolyte to a spark plasma sintering device.

Specifically, the mold may be filled with the prepared amorphous solid electrolyte powder and then may be mounted in the chamber of the spark plasma sintering device. In this case, boron nitride may be applied as a high-temperature release agent to the surface of the punch to prevent the solid electrolyte layer from adhering to the punch.

Then, the atmosphere of the spark plasma sintering device may be evacuated to a vacuum or equivalent state. Subsequently, the punch may be moved to apply reaction pressure to the amorphous solid electrolyte filling the mold.

With the reaction pressure applied, the spark plasma sintering device may be heated to a predetermined reaction temperature. Then, the reaction pressure and reaction temperature may be maintained for a predetermined reaction time. During this process, the amorphous solid electrolyte may be crystallized and converted into a crystalline solid electrolyte. At the same time, pressure is applied to the amorphous or crystalline solid electrolyte in the mold, so that a solid electrolyte layer corresponding to the shape and size of the mold can be formed.

While maintaining the reaction pressure and reaction temperature, the crystallization reaction may be performed for a predetermined reaction time. When the desired reaction time has elapsed, the reaction pressure may be released and the temperature of the spark plasma sintering device or chamber may be cooled to room temperature. Then, the punch is removed using cold press equipment and then the manufactured solid electrolyte layer or pellet may be removed.

In one embodiment, the reaction pressure applied to the amorphous solid electrolyte may be 10 MPa to 90 MPa. In contrast, the conventional method of manufacturing a solid electrolyte layer by heat treating an amorphous solid electrolyte for a long time and applying high pressure, typically uses a pressure of about 370 MPa to about 550 MPa.

The reaction pressure according to the present disclosure may be set at a relatively very low pressure compared to the conventional method to perform crystallization and production of the solid electrolyte layer. Accordingly, even when increasing the size of the mold, an appropriate reaction pressure may be applied to the amorphous solid electrolyte, which is advantageous for increasing the area of the mold.

When the reaction pressure applied to the amorphous solid electrolyte is less than 10 MPa, the crystallization reaction may not be performed properly. In addition, when the reaction pressure is higher than 90 MPa, it may be disadvantageous for increasing the area of the mold.

In one embodiment, the reaction temperature may be 500K to 700K. In addition, the reaction time for which the reaction temperature is maintained may be 5 to 10 minutes. In the conventional method of manufacturing a solid electrolyte layer by heat treating an amorphous solid electrolyte for a long time and applying high pressure, generally, a temperature of 723K to 773K may be maintained for 1 to 5 hours to crystallize the amorphous solid electrolyte.

In the manufacture method according to the present disclosure, crystallization and production of a solid electrolyte layer may be achieved by maintaining a relatively low reaction temperature for a much shorter time. Accordingly, the elements constituting the solid electrolyte may be evenly dispersed without agglomeration.

The spark plasma sintering according to the present disclosure does not require maintenance of high heat treatment temperature for a long time as in the conventional method, thus reducing the size of the heat treatment furnace. Accordingly, it is possible to suppress quality degradation of the crystalline solid electrolyte due to temperature imbalance in the heat treatment furnace. Here, the quality degradation may mean a decrease in crystallinity of the solid electrolyte, a decrease in density due to agglomeration of elements constituting the solid electrolyte, and thus a decrease in lithium ion conductivity.

Meanwhile, the agglomeration of the elements constituting the solid electrolyte can be confirmed by visually observing the image of the solid electrolyte layer analyzed by energy dispersive X-ray spectroscopy (EDS).

When the reaction temperature is less than 500K or the reaction time is less than 5 minutes, the crystallization reaction of the amorphous solid electrolyte may not occur properly. In addition, when the reaction temperature is higher than 700 K or the reaction time is longer than 10 minutes, the crystalline structure may collapse due to excessive volatilization of a specific element, for example, sulfur(S), in the amorphous solid electrolyte.

In one embodiment, the temperature increase rate to reach the reaction temperature may be 30 K/min to 100 K/min. When the temperature increase rate to reach the reaction temperature is less than 30 K/min and the amorphous solid electrolyte in the mold is heated too slowly, insufficient heat may be applied and crystallization may not occur completely.

On the other hand, when the temperature increase rate to reach the reaction temperature is higher than 100 K/min and the amorphous solid electrolyte in the mold is heated at an excessively high rate, excessively much heat is added in a short period of time, thus causing the risk that the crystal structure will collapse due to excessive volatilization of sulfur(S), which is a specific element in the amorphous solid electrolyte.

As such, a crystalline solid electrolyte and a solid electrolyte layer containing it may be manufactured by crystallizing the amorphous solid electrolyte using spark plasma sintering.

The crystalline solid electrolyte is a material with high lithium ion conductivity, and oxide-based solid electrolytes and sulfide-based solid electrolytes are known. However, it is preferable to use sulfide-based solid electrolytes that are inexpensive, have high lithium ion conductivity, and have low electronic conductivity.

The sulfide-based solid electrolyte is not particularly limited and is Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (wherein m and n are positive numbers, and Z is Ge, Zn, or Ga), Li₂S—GeS₂, Li₂S—SiS₂—Li₃PO₄, Li₂S—SiS₂—LiₓMO_{y} (wherein x and y are positive numbers, and M is P, Si, Ge, B, Al, Ga, or In), Li₁₀GeP₂S₁₂ or the like.

In addition, the crystalline solid electrolyte may have an argyrodite-type crystal structure. The argyrodite-type crystal structure is a solid electrolyte that has lithium ion conductivity while having the same crystal structure as argyrodite ore having a composition of Ag₈GeS₆. In all-solid-state batteries, Li₇PS₆ and Li₆PS₅X (X═Cl, Br, I) are representative electrolytes with a Li-argyrodite structure having lithium ion (Li⁺) conductivity.

In one embodiment, the crystalline solid electrolyte may be represented by the following Formula.

[Formula]

Li_{6+x-a-y}A₁₋ₓMₓS₅₋ₐX₁₊ₐ
wherein A is P or Sb, M is Si, Ge or Sn, X includes any one selected from the group consisting of Cl, Br, I and combinations thereof, x satisfies 0≤x≤0.5, y satisfies 0≤y≤0.2, and a satisfies 0≤a≤0.5.

In Formula, when a is higher than 0, the halogen is rich. In addition, when y is higher than 0, lithium may be deficient. In addition, although not shown in Formula, some of the sulfur(S) may be replaced with selenium (Se).

In one embodiment, when A in Formula is phosphorus (P), the reaction temperature at which crystallization occurs by spark plasma sintering may be 523K to 600K. In addition, when A in Formula above is antimony (Sb), the reaction temperature at which crystallization occurs through spark plasma sintering may be 573K to 673K.

When A in Formula is phosphorus (P), that is, when an amorphous solid electrolyte containing phosphorus (P) is crystalized using spark plasma sintering, crystallization may not occur properly at a reaction temperature lower than 523K. In addition, at a reaction temperature higher than 600K, the crystal structure may collapse due to excessive volatilization of sulfur(S).

When A in Formula is antimony (Sb), that is, when an amorphous solid electrolyte containing antimony (Sb) is crystallized using spark plasma sintering, crystallization may not occur properly at a reaction temperature lower than 573K. In addition, at a reaction temperature higher than 673K, the crystal structure may collapse due to excessive volatilization of sulfur(S).

The solid electrolyte layer containing a crystalline solid electrolyte according to the manufacturing method of the present disclosure exhibits higher density, improved lithium ion conductivity, and lower electronic conductivity than the solid electrolyte layer manufactured by the conventional method.

In one embodiment, the ionic conductivity of the solid electrolyte layer may be 1.30*10⁻³ S/cm or more. In addition, the density of the solid electrolyte layer may be 88% to 99% of the theoretical density. Furthermore, the electronic conductivity of the solid electrolyte layer may be 1.09*10⁻⁹ S/cm or less.

Hereinafter, the present disclosure will be described in more detail with reference to the following examples and comparative examples and the like. However, these examples and comparative examples should not be construed as limiting the scope of the present disclosure.

### Preparation Example 1—Amorphous Li_{6.25}Sb_{0.75}Ge_{0.25}S₅I

To synthesize an amorphous solid electrolyte having a composition of Li_{6.25}Sb_{0.75}Ge_{0.25}S₅I, Li₂S, Ge, Sb, S, and LiI were prepared as solid electrolyte raw materials. 70 g of zirconia balls with a diameter of 10 mm and a total of 3 g of the prepared solid electrolyte raw material were added to a ball mill container to match the stoichiometric calculation.

The ball mill container was operated at 350 rpm for 20 hours to synthesize an amorphous solid electrolyte having a composition of Li_{6.25}Sb_{0.75}Ge_{0.25}S₅I.

### Preparation Example 2—Amorphous Li₆PS₅Cl

To synthesize an amorphous solid electrolyte having a composition of Li₆PS₅Cl, Li₂S, P₂S₅, and LiCl were prepared as solid electrolyte raw materials. 70 g of zirconia balls with a diameter of 10 mm and a total of 3 g of the prepared solid electrolyte raw material were added to a ball mill container to match the stoichiometric calculation.

The ball mill container was operated at 350 rpm for 20 hours to synthesize an amorphous solid electrolyte having a composition of Li₆PS₅Cl.

### Example 1—Preparation Example 1+Spark Plasma Sintering

A spark plasma sintering device (SPS Syntex Co., Ltd.; SPS-210LX) was prepared. The size of the punch mounted on the spark plasma sintering device was 13 mm and a mold of the appropriate size for the punch was prepared. Boron nitride was sprayed to the punch to prevent the prepared solid electrolyte layer from adhering to the punch.

The amorphous solid electrolyte in powder form synthesized according to Preparation Example 1 was injected into the mold and then a punch was installed to press the powder in both directions.

The mold was mounted in the chamber of the spark plasma sintering device and then the chamber was evacuated. Then, a reaction pressure of about 50 MPa was applied. The temperature of the chamber was increased at a rate of 50 K/min to reach a reaction temperature of 623 K while maintaining the reaction pressure. The crystallization process was performed for 8 minutes, maintaining the reaction pressure and reaction temperature. After 8 minutes, the reaction pressure was released, and the chamber was cooled to room temperature.

Then, the punch was removed using cold press equipment and the prepared solid electrolyte layer was collected.

### Example 2—Preparation Example 2+Spark Plasma Sintering

A solid electrolyte layer was prepared using the same process as in Example 1, except that Preparation Example 2 was used as an amorphous solid electrolyte, and the reaction temperature and reaction time were set to 523K and 5 minutes, respectively.

### Comparative Example 1—Preparation Example 1+Long-Term Heat Treatment and High-Pressure Pressing

The amorphous solid electrolyte according to Preparation Example 1 was placed in a heat treatment furnace, a vacuum atmosphere was created, and heat treatment was performed at about 723 K for 24 hours. A crystalline solid electrolyte was prepared through the heat treatment.

The crystalline solid electrolyte was injected into a pressurized mold and a pressure of about 400 MPa was applied to prepare a solid electrolyte layer.

### Comparative Example 2—Preparation Example 1

The amorphous solid electrolyte according to Preparation Example 1 was injected into a pressurized mold without performing separate heat treatment, and then a pressure of about 400 MPa was applied thereto to prepare a solid electrolyte layer.

### Comparative Example 3—Preparation Example 2+long-term heat treatment and high-pressure pressing

A solid electrolyte layer was manufactured in the same process as in Comparative Example 1, except that the amorphous solid electrolyte according to Preparation Example 2 was used.

### Experimental Example 1—Confirmation of Crystallinity of Solid Electrolyte Through XRD Analysis

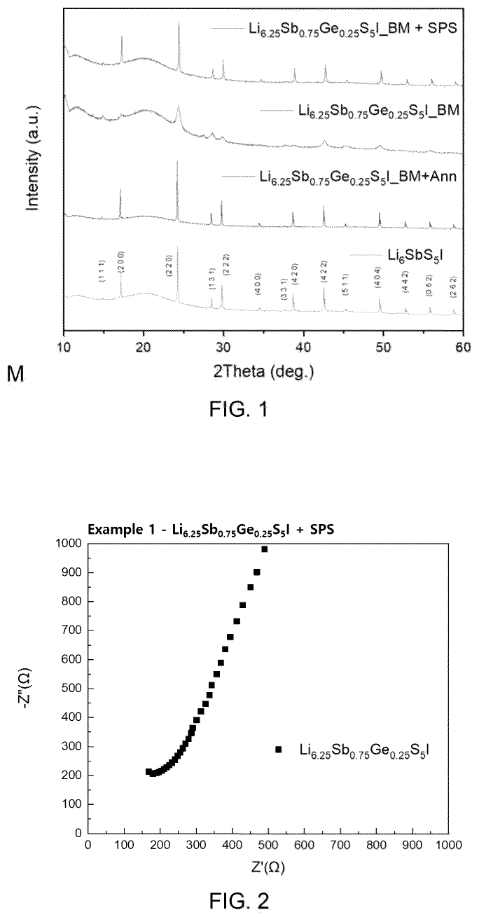

In order to determine whether or not the crystalline solid electrolyte was synthesized correctly, XRD (X-ray diffraction) analysis was performed on the solid electrolyte layers according to Example 1, Comparative Example 1, and Comparative Example 2. The results were compared with the known Li₆SbS₅l XRD peaks, as shown in FIG. 1. In the graph, BM represents ball milling, SPS represents spark plasma sintering, and ANN represents heat treatment (annealing).

As can be seen from FIG. 1, a solid electrolyte layer (Comparative Example 1; BM+ANN) manufactured by performing heat treatment for a long time and applying pressure with a high pressure press, and a solid electrolyte layer (Example 1; BM+SPS) manufactured within a short time of minutes using spark plasma sintering was manufactured with the same crystalline solid electrolyte. Considering manufacturing time and process, according to the present disclosure, it is possible to efficiently manufacture a crystalline solid electrolyte layer while effectively suppressing volatilization of sulfur for a short period of time.

Meanwhile, Comparative Example 2 (BM), which did not undergo a crystallization process such as long-term heat treatment or spark plasma sintering, did not exhibit peaks, which indicates that the solid electrolyte remained in an amorphous state.

### Experimental Example 2—Measurement of Physical Properties of Synthesized Solid Electrolyte

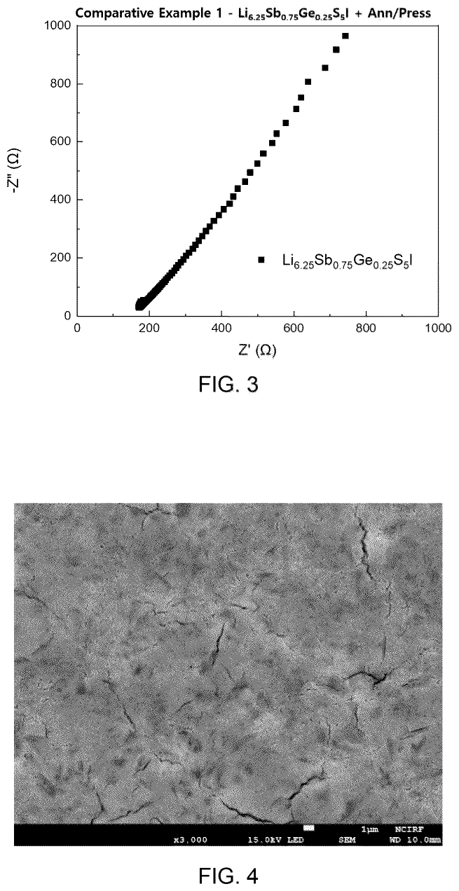

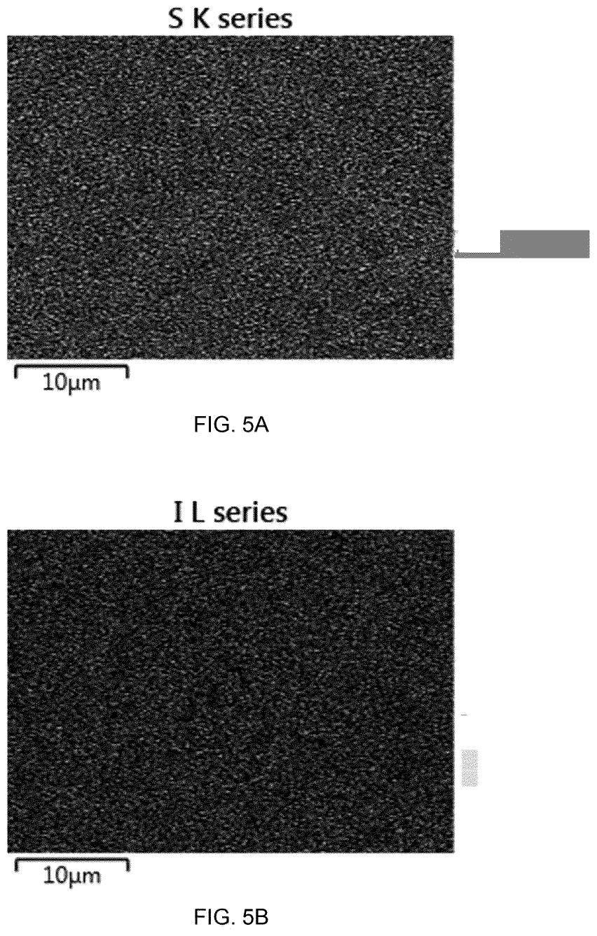

Impedance evaluation was performed to determine the ionic conductivity and electronic conductivity of the solid electrolyte layers according to Example 1 and Comparative Example 1. The results of Nyquist impedance plot through impedance analysis are shown in FIGS. 2 and 3.

As can be seen from FIG. 2, the solid electrolyte layer manufactured using spark plasma sintering had a thickness of about 0.1 cm and a density of 2.6 g/cm³. In addition, the ionic conductivity and the electronic conductivity measured or calculated from the impedance evaluation were 1.34*10⁻³ S/cm and 1.09*10⁻⁹ S/cm, respectively.

As can be seen from FIG. 3, the conventional solid electrolyte layer manufactured using long-term heat treatment and high-pressure pressing had a thickness of about 0.056 cm and a density of 1.87 g/cm³. In addition, the ionic conductivity and the electronic conductivity measured or calculated from the impedance evaluation were 4.72*10⁻⁴ S/cm and 5.63*10⁻⁹ S/cm, respectively.

Comparing FIG. 2 with FIG. 3, the spark plasma sintering increased the density of the solid electrolyte layer by about 40% and the ionic conductivity by about 3 times. At the same time, electronic conductivity decreased by about two times.

### Experimental Example 3—Image Analysis of Solid Electrolyte (Li_{6.25}Sb_{0.75}Ge_{0.25}S₅I)

Image analysis was performed on the synthesized solid electrolyte layer to investigate the cause of the differences in density, ionic conductivity, and electronic conductivity of the solid electrolyte layer measured in Experimental Example 2.

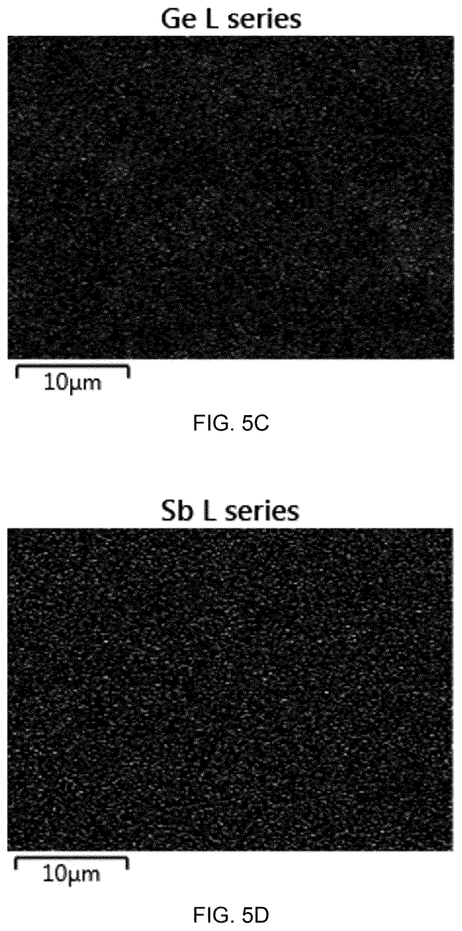

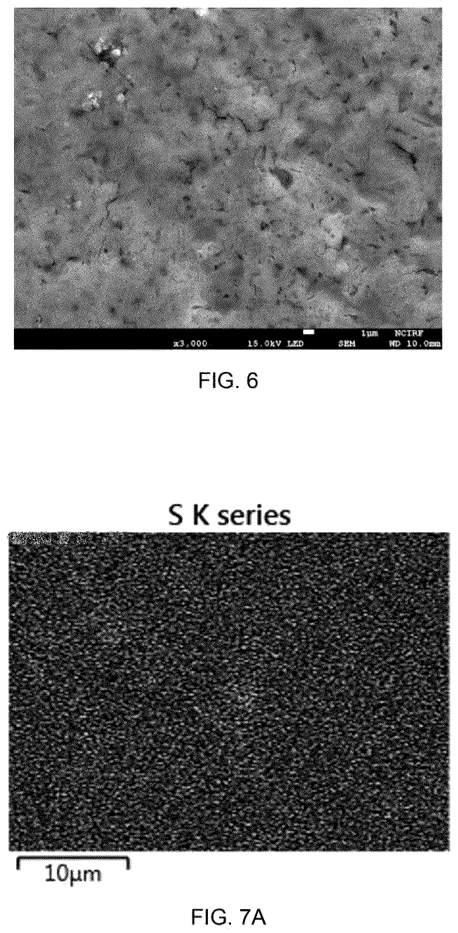

FIG. 4 is a scanning electron microscope (SEM, ×3,000) image showing the solid electrolyte layer according to Example 1. FIGS. 5A to 5D are energy dispersive X-ray spectroscopy (EDS) images of sulfur(S), iodine (I), germanium (Ge), and antimony (Sb), respectively, in the solid electrolyte layer according to Example 1.

As can be seen from FIG. 4, although voids are observed inside the solid electrolyte layer according to Example 1, their number and size thereof are smaller than those of Comparative Example 1, which will be described later. In addition, as can be seen from FIGS. 5A to 5D, each element constituting the crystalline solid electrolyte is evenly dispersed and does not aggregate.

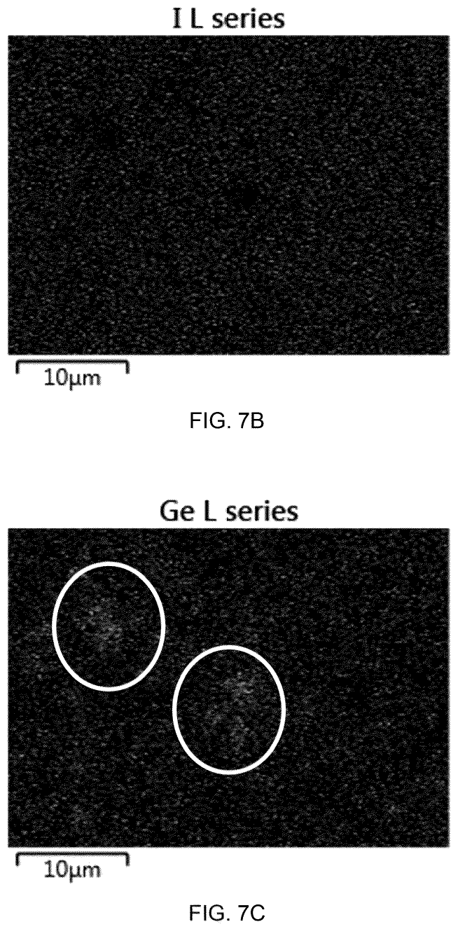

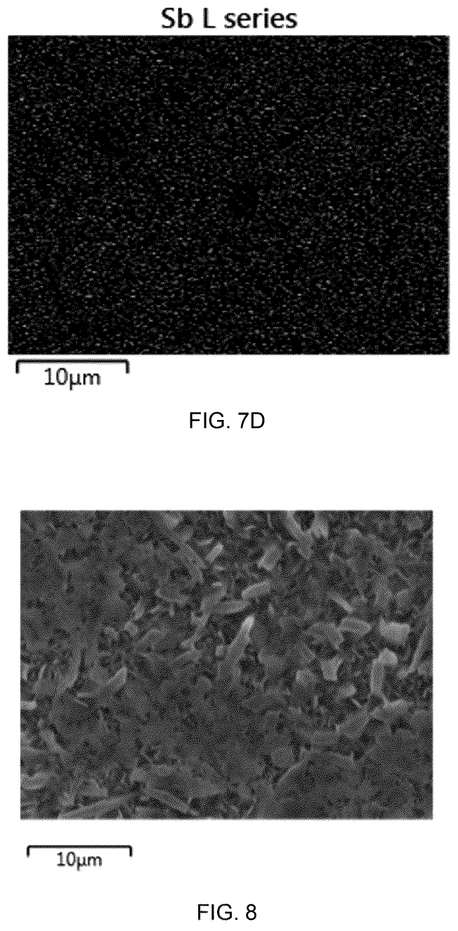

FIG. 6 is a scanning electron microscope (SEM, ×3,000) image showing the solid electrolyte layer according to Comparative Example 1. FIGS. 7A to 7D are energy dispersive X-ray spectroscopy (EDS) images of sulfur(S), iodine (I), germanium (Ge), and antimony (Sb), respectively, in the solid electrolyte layer according to Comparative Example 1.

As can be seen from FIG. 6, the solid electrolyte layer according to Comparative Example 1 have more voids, compared to Example 1. The pores act as a resistance to prevent the conduction of lithium ions, and reduce the overall density of the solid electrolyte layer and thus the energy density of the cell.

In addition, as can be seen from FIGS. 7A to 7D, germanium (Ge), an element constituting the crystalline solid electrolyte, appears brighter in the EDS phase, which means that it is not evenly dispersed and is unevenly clustered. It is predicted that non-uniform arrangement of elements occurred due to the temperature gradient of the heat treatment furnace. The non-uniformity of these elements may impede the uniform movement of lithium ions, thereby reducing battery performance.

The results of the image analysis for FIGS. 4 to 7D are expressed numerically in Tables 1 and 2 below. Table 1 relates to the solid electrolyte layer according to Example 1 and Table 2 relates to the solid electrolyte layer according to Comparative Example 1.

TABLE 1

| | | | | Standard | |
|---|---|---|---|---|---|
| Element | Line Type | Wt % | Wt % σ | Label | Atomic % |
| S | K series | 29.93 | 0.13 | FeS₂ | 35 |
| Ge | L series | 7.92 | 0.09 | Ge | 4.0 |
| Sb | L series | 13.81 | 0.14 | Sb | 4.1 |
| I | L series | 29.02 | 0.17 | I (v) | 8.31 |

TABLE 2

| | | | | Standard | |
|---|---|---|---|---|---|
| Element | Line Type | Wt % | Wt % σ | Label | Atomic % |
| S | K series | 29.31 | 0.1 | FeS₂ | 32.9 |
| Ge | L series | 6.22 | 0.07 | Ge | 3.2 |
| Sb | L series | 14.67 | 0.11 | Sb | 4.5 |
| I | L series | 31.3 | 0.14 | I (v) | 9.1 |

As can be seen from Tables 1 and 2, there is a difference in the content of elements although the same amorphous solid electrolyte as in Preparation Example 1 is used. In particular, it can be seen that the content of sulfur(S) is higher (35 at % vs. 32.9 at %) in Example 1 using spark plasma sintering. This is because volatilization of sulfur is suppressed in Example 1, where the crystallization time is short.

### Experimental Example 4—Image Analysis of Solid Electrolyte (Li₆PS₅Cl)

In order to determine whether or not the amorphous solid electrolyte (Li₆PS₅Cl) according to Preparation Example 2 exhibits high ionic conductivity, low electronic conductivity, improved dispersibility, and suppressed sulfur volatilization when using the spark plasma sintering is used, image analysis was performed on Example 2 and Comparative Example 3.

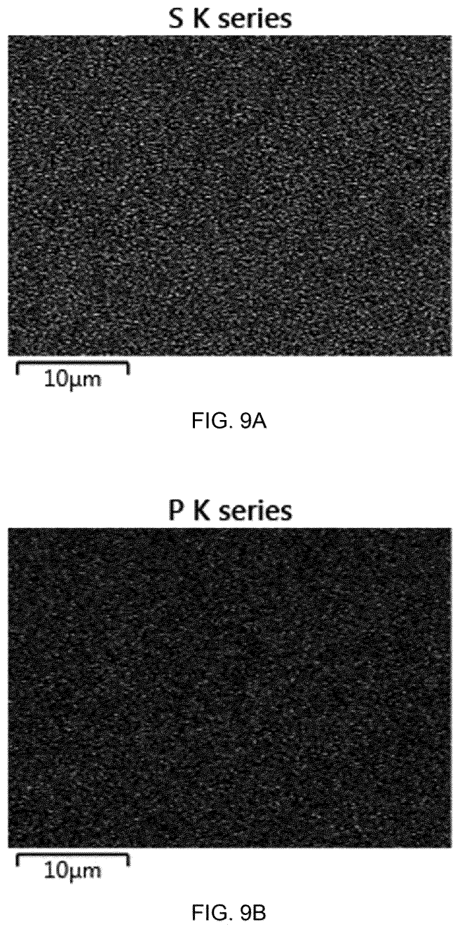

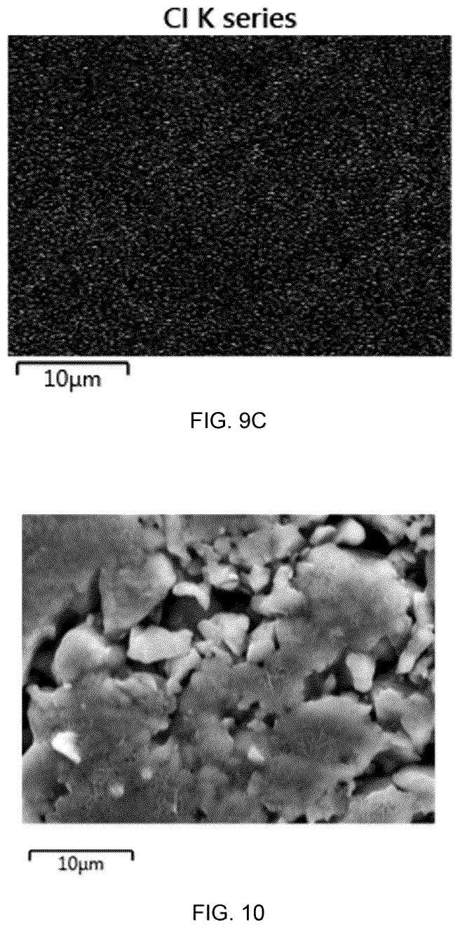

FIG. 8 is a scanning electron microscope (SEM, ×3,000) image showing the solid electrolyte layer according to Example 2. FIGS. 9A to 9C are energy dispersive X-ray spectroscopy (EDS) images of sulfur(S), phosphorus (P), and chlorine (Cl), respectively, in the solid electrolyte layer according to Example 2.

As can be seen from FIG. 8, although voids are observed inside the solid electrolyte layer according to Example 2, the number and size thereof are smaller than those of Comparative Example 3, which will be described later. In addition, as can be seen from FIGS. 9A to 9C, each element constituting the crystalline solid electrolyte is evenly dispersed and does not aggregate.

Although not separately shown, the ionic conductivity of the solid electrolyte layer according to Example 2 was measured to be 1.83*10⁻³ S/cm. This is more than two times higher than the ionic conductivity of the solid electrolyte layer according to Comparative Example 3, which will be described later.

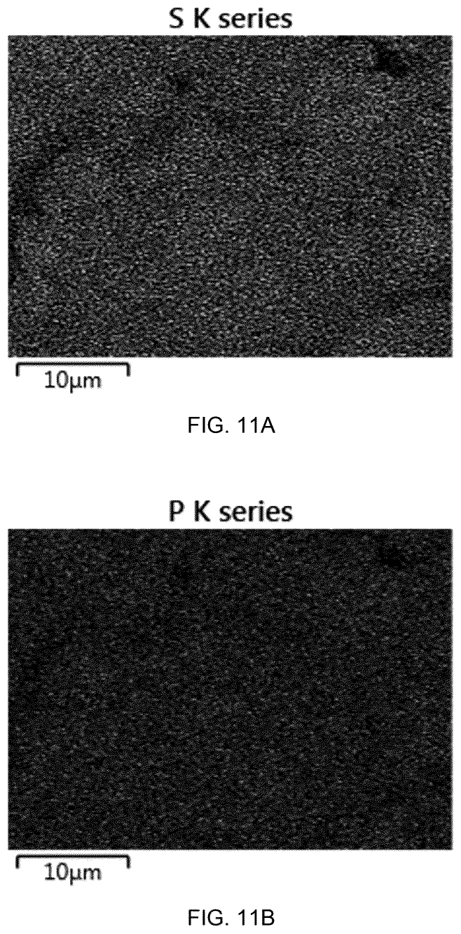

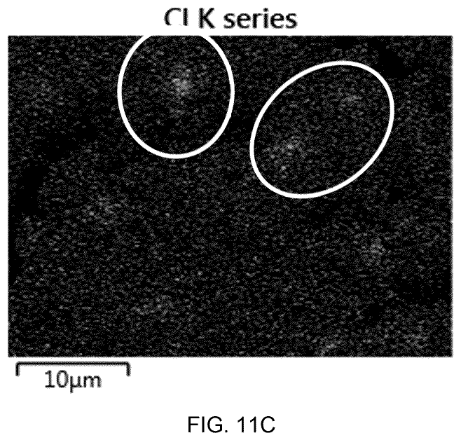

FIG. 10 is a scanning electron microscope (SEM, ×3,000) image showing the solid electrolyte layer according to Comparative Example 3. FIGS. 11A to 11C are energy dispersive X-ray spectroscopy (EDS) images of sulfur(S), phosphorus (P), and chlorine (Cl), respectively, in the solid electrolyte layer according to Comparative Example 3.

As can be seen from FIG. 10, the solid electrolyte layer according to Comparative Example 1 has more voids, compared to Example 2. These pores act as a resistance, hindering the conduction of lithium ions and to reduce the overall density of the solid electrolyte layer and thus the energy density of the cell.

In addition, as can be seen from FIGS. 11A to 11C, chlorine (Cl), an element constituting the crystalline solid electrolyte, appears brighter in the EDS phase, which indicates that it is not evenly dispersed and is unevenly clustered. It is predicted that non-uniform arrangement of elements occurred due to the temperature gradient of the heat treatment furnace. Non-uniformity of these elements may impede the uniform movement of lithium ions and reduce battery performance.

Although not separately shown, the ionic conductivity of the solid electrolyte layer according to Comparative Example 3 was measured to be 8.9*10⁻⁴ S/cm, which is more than two times lower than the ionic conductivity of the solid electrolyte layer according to Example 3.

The results of the image analysis for FIGS. 8 to 11C are expressed numerically in Tables 3 and 4 below. Table 3 relates to the solid electrolyte layer according to Example 2 and Table 4 relates to the solid electrolyte layer according to Comparative Example 3.

TABLE 3

| | | | | Standard | |
|---|---|---|---|---|---|
| Element | Line Type | Wt % | Wt % σ | Label | Atomic % |
| P | K series | 10.96 | 0.07 | GaP | 8.23 |
| S | K series | 46.32 | 0.23 | FeS₂ | 33.6 |
| Cl | K series | 10.93 | 0.08 | NaCl | 7.17 |

TABLE 4

| | | | | Standard | |
|---|---|---|---|---|---|
| Element | Line Type | Wt % | Wt % σ | Label | Atomic % |
| P | K series | 10.32 | 0.06 | GaP | 7.45 |
| S | K series | 43.18 | 0.2 | FeS₂ | 30.1 |
| Cl | K series | 10.67 | 0.07 | NaCl | 6.73 |

As can be seen from Tables 3 and 4, there is a difference in the content of elements although the same amorphous solid electrolyte as in Preparation Example 2 was used. In particular, it can be seen that the content of sulfur(S) is higher (33.6 at % vs. 30.1 at %) in Example 2 where the spark plasma sintering method was applied. This is because volatilization of sulfur was suppressed in Example 2, where the crystallization time was short.

As such, the solid electrolyte layer manufactured using the spark plasma sintering according to the present disclosure can effectively suppress volatilization of elements such as sulfur as crystallization and production of the solid electrolyte layer are achieved within a short time. In addition, the density of the manufactured solid electrolyte layer was approximately 88% to 99% of the theoretical density. This was confirmed by inputting the size of the unit cell for the solid electrolyte constituting the manufactured solid electrolyte layer and the type and number of elements contained therein into the Inorganic Crystal Structure Database (ICSD).

Accordingly, the solid electrolyte layer manufactured through the present disclosure can increase the density of the solid electrolyte layer by about 40% compared to the conventional method using long-term heat treatment and high pressure, improve ionic conductivity by about 3 times, and decrease electronic conductivity by about 2 times.

As is apparent from the foregoing, the present disclosure provides a method of manufacturing a solid electrolyte layer that uses spark plasma sintering, which allows for the production of a solid electrolyte layer within several minutes without a long-time heat treatment process.

In addition, the present disclosure provides a method of manufacturing a solid electrolyte layer that can provide a solid electrolyte layer with a higher density compared to a conventional manufacturing method that involves heat treatment under high pressure for a long time. Accordingly, the lithium ion conductivity of the solid electrolyte layer can be improved.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

What is claimed is:

1. A method of manufacturing a solid electrolyte layer comprising:
preparing an amorphous solid electrolyte; and
crystallizing the amorphous solid electrolyte using spark plasma sintering (SPS) to manufacture a solid electrolyte layer comprising a crystalline solid electrolyte.

2. The method according to claim 1, wherein the preparing the amorphous solid electrolyte comprises performing mechanical milling on solid electrolyte raw materials.

3. The method according to claim 2, wherein the mechanical milling comprises at least one selected from the group consisting of ball milling, airjet milling, bead milling, roll milling, planetary milling, hand milling, high energy ball milling, planetary ball milling, stirred ball milling, vibrating milling, mechanofusion milling, shaker milling, planetary milling, attritor milling, disk milling, shape milling, Nauta milling, Nobilta milling, high speed mixing, and combinations thereof.

4. The method according to claim 1, wherein the crystallizing the amorphous solid electrolyte using SPS comprises:
placing the amorphous solid electrolyte in a spark plasma sintering device;
vaccumizing the spark plasma sintering device and applying a reaction pressure thereto;
ramping a temperature of the spark plasma sintering device to a reaction temperature while maintaining the reaction pressure thereto; and
maintaining the reaction temperature for a predetermined reaction time to crystallize the amorphous solid electrolyte into the crystalline solid electrolyte.

5. The method according to claim 4, wherein the reaction pressure is about 10 MPa to 90 MPa.

6. The method according to claim 4, wherein the reaction time is about 5 to 10 minutes.

7. The method according to claim 4, wherein the reaction temperature is about 500 K to 700 K.

8. The method according to claim 4, wherein a temperature increase rate to reach the reaction temperature is about 30 K/min to 100 K/min.

9. The method according to claim 4, further comprising cooling the crystalline solid electrolyte to room temperature after the crystallization.

10. The method according to claim 1, wherein the crystalline solid electrolyte comprises a sulfide-based solid electrolyte.

11. The method according to claim 1, wherein the crystalline solid electrolyte comprises an argyrodite-type crystal structure.

12. The method according to claim 1, wherein the crystalline solid electrolyte is represented by a following Formula:
Li_{6+x-a-y}A₁₋ₓMₓS₅₋ₐX₁₊ₐ
wherein
A is P or Sb;
M is Si, Ge or Sn;
X comprises any one selected from the group consisting of Cl, Br, I and combinations thereof; and
x satisfies 0≤x≤0.5, y satisfies 0≤y≤0.2, and a satisfies 0≤a≤0.5, respectively.

13. The method according to claim 12, wherein, when A in the Formula is P, spark plasma sintering is performed at a reaction temperature of about 523K to 600K.

14. The method according to claim 12, wherein, when A in the Formula is Sb, spark plasma sintering is performed at a reaction temperature of about 573K to 673K.

15. The method according to claim 1, wherein the solid electrolyte layer has an ionic conductivity of about 1.30*10⁻³ S/cm or more.

16. The method according to claim 1, wherein a density of the solid electrolyte layer is about 88% to 99% of a theoretical density of the solid electrolyte.

17. The method according to claim 1, wherein each element constituting the crystalline solid electrolyte is dispersed without agglomeration.

18. A solid electrolyte layer comprising a crystalline solid electrolyte crystallized using spark plasma sintering (SPS),
wherein the crystalline solid electrolyte comprises a sulfide-based solid electrolyte.

19. The solid electrolyte layer according to claim 18, wherein the solid electrolyte layer has an ionic conductivity of about 1.30*10⁻³ S/cm or more.

20. The solid electrolyte layer according to claim 18, wherein each element constituting the crystalline solid electrolyte is dispersed without agglomeration.
